(19) United States
(12) Patent Application Publication
(10) Pub. No.: US 2026/0240710 A1
(43) Pub. Date: Aug. 20, 2026

(54) THERAPEUTIC DEVICE AND METHOD FOR TREATING CARPAL TUNNEL SYNDROME

(71) Applicants: Mark Messinger, Windham, NH (US); Adam Samansky, Andover, MA (US)

(72) Inventors: Mark Messinger, Windham, NH (US); Adam Samansky, Andover, MA (US)

(21) Appl. No.: 19/058,999

(22) Filed: Feb. 20, 2025

(51) Int. Cl. A61H 1/02; A41D 19/00

(52) U.S. Cl. CPC A61H 1/0288; A41D 19/0024; A61H 2201/1638; A61H 2201/165; A61H 2201/5053

(57) ABSTRACT

An apparatus and method for treating carpal tunnel syndrome are disclosed. The apparatus can include a glove configured to be worn on a hand of a user, the glove including a palm section accommodating a palm of the hand and a plurality of finger sections each of which accommodating a finger of the hand when in use, and a tensioning system. The tensioning system can include a tensioning wire including a first section coupled to a first finger section and a second section coupled to a second finger section, and a tension controlling element for adjustably controlling a tension of the tensioning wire. The tension controlling element can increase the tension of the tensioning wire, causing a stretch of thenar and hypothenar muscles of the hand when in use, and can decrease the tension of the tensioning wire, causing a release of the stretch.

### TECHNICAL FIELD

The present disclosure relates generally to wearable therapeutic devices, and more particularly, to a therapeutic device and method for treating carpal tunnel syndrome.

### BACKGROUND

Carpal tunnel syndrome is a common condition, affecting anywhere from four to ten million Americans, that causes numbness, tingling, and pain in the hand and forearm. The carpal tunnel is a narrow passageway inside the wrist containing flexor tendons that bend the fingers and thumb and the median nerve which both allows for feeling in the fingers and thumb and controls muscles around the base of the thumb. Carpal tunnel syndrome occurs when the tunnel is constricted, or when the tissue surrounding the flexor tendons swells, thus squeezing or compressing the median nerve and reducing its blood supply. If left untreated, it can lead to permanent nerve damage and dysfunction of the hand, causing loss of sensation in the fingers and weakness of the hand.

Various forms of invasive and non-invasive treatment for carpal tunnel syndrome exist. These include a variety of splints and braces, over-the-counter pain medication, nonsteroidal anti-inflammatory drugs (NSAIDs), physical therapy, cortisone injections, and surgical intervention in severe cases. Most wrist splints, such as cock-up wrist splints, are designed to keep the wrist stabilized in one position in an attempt to relieve symptoms by avoiding wrist flexion. However, these devices do not offer any form of therapeutic treatment as they merely hold the wrist in a neutral plane or in slight extension, providing only temporary relief of the symptoms without addressing the actual cause of carpal tunnel syndrome. Moreover, physical therapy is time-consuming, often expensive, and even with a home exercise program taught by a trained therapist, the symptoms may return if repetitive or aggravating factors are not removed from activities of daily living.

### SUMMARY

The present disclosure provides an adjustable device that can be worn as a glove and create torque over time to the flexor surface of the wrist in order to treat and relieve symptoms of carpal tunnel syndrome and chronic wrist pain. The device can include a tensioning system that moves the hand into dorsiflexion while releasably stretching the thenar and hypothenar portions of the hand, thereby stretching out the carpal tunnel and in effect relieving pressure on the median nerve.

According to embodiments of the present disclosure, an apparatus for treating carpal tunnel syndrome can include: a glove configured to be worn on a hand of a user, where the glove includes a palm section accommodating a palm of the hand and a plurality of finger sections each of which accommodating a finger of the hand when in use; and a tensioning system which includes a tensioning wire including a first section coupled to a first finger section of the plurality of finger sections and a second section coupled to a second finger section of the plurality of finger sections, and a tension controlling element for adjustably controlling a tension of the tensioning wire. The tension controlling element can be configured to increase the tension of the tensioning wire, causing a stretch of thenar muscles and hypothenar muscles of the hand when in use, and configured to decrease the tension of the tensioning wire, causing a release of the stretch of the thenar and hypothenar muscles when in use.

In some embodiments, when the tension controlling element increases the tension of the tensioning wire, the tensioning wire can be configured to apply torque to the thenar and hypothenar muscles, causing the stretch. The torque can be applied laterally at the thenar muscles and medially at the hypothenar muscles. When the tension controlling element decreases the tension of the tensioning wire, the tensioning wire can be configured to reduce the torque applied to the thenar and hypothenar muscles, causing the release of the stretch.

In some embodiments, when the tension controlling element increases the tension of the tensioning wire, the hand can be caused to bend into dorsiflexion while the thenar and hypothenar muscles are stretched.

In some embodiments, the tensioning wire can be at least partially located within of a lumen of the glove. The first finger section can include a first lumen within which the first section of the tensioning wire is located, and the second finger section can include a second lumen within which the second section of the tensioning wire is located.

In some embodiments, the first section of the tensioning wire can be attached to the first finger section, and the second section of the tensioning wire can be attached to the second finger section.

In some embodiments, the first section of the tensioning wire can wrap around the first finger section, and the second section of the tensioning wire can wrap around the second finger section.

In some embodiments, the first finger section can be configured to accommodate a pinky of the hand, and the second finger section can be configured to accommodate a thumb of the hand. When the tension controlling element increases the tension of the tensioning wire, the thumb and the pinky can be pulled toward a posterior side of the hand when in use.

In some embodiments, the tension controlling element can include a rotary knob configured to increase or decrease the tension of the tensioning wire. The rotary knob can be configured such that rotation of the rotary knob in a first direction causes the tension of the tensioning wire to increase. The rotary knob can be further configured such that an upward pull exerted on the rotary knob or rotation of the rotary knob in a second direction causes the tension of the tensioning wire to decrease.

In some embodiments, the tension controlling element can include a motorized gear assembly configured to increase or decrease the tension of the tensioning wire. The tension controlling element can further include one or more input elements configured to control operation of the motorized gear assembly. Additionally, the motorized gear assembly can be configured to operate according to a predefined algorithm, causing the motorized gear assembly to increase and decrease the tension of the tensioning wire according to a predefined schedule and by predefined amounts of torque. For example, execution of the predefined algorithm can cause the motorized gear assembly to, in order: 1) increase the tension of the tensioning wire to a first amount of torque for a first period of time, 2) decrease the tension of the tensioning wire to a second amount of torque less than the first amount of torque for a second amount of time, and 3) increase the tension of the tensioning wire to a third amount of torque greater than the first amount of torque for a third period of time.

In some embodiments, the tension controlling element can be located at a posterior side of the hand or a wrist of the user when in use.

In some embodiments, the glove can further include a routing element adjacent to the hypothenar muscles, the routing element being coupled to the tensioning wire and configured to route a portion of tensioning wire along a length of the hypothenar muscles.

In some embodiments, the tensioning wire is made of stainless steel.

Furthermore, in accordance with embodiments of the present disclosure, a method for treating carpal tunnel syndrome using a glove configured to be worn on a hand of a user, the glove comprising a palm section accommodating a palm of the hand and a plurality of finger sections each of which accommodating a finger of the hand when in use, can include: executing, via a tension controlling element, a first adjustment of tension of a tensioning wire in which the tension of the tensioning wire is increased to a first amount of torque for a first period of time, causing a stretch of thenar muscles and hypothenar muscles of the hand; executing, via the tension controlling element, a second adjustment of tension of the tensioning wire in which the tension of the tensioning wire is decreased to a second amount of torque less than the first amount of torque for a second period of time, causing a release of the stretch of the thenar and hypothenar muscles; and executing, via the tension controlling element, a third adjustment of tension of the tensioning wire in which the tension of the tensioning wire is increased to a third amount of torque greater than the first amount of torque for a third period of time, causing an additional stretch of the stretch of the thenar and hypothenar muscles. The tensioning wire can include a first section coupled to a first finger section of the plurality of finger sections and a second section coupled to a second finger section of the plurality of finger sections.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1C are anatomical diagrams of the wrist and hand showing structures pertinent to carpal tunnel syndrome;

FIG. 2 is a simplified sketch of a therapeutic device for treating carpal tunnel syndrome according to embodiments of the present disclosure;

FIGS. 3A-3C are perspective views of the therapeutic device of FIG. 2 with a first tensioning system according to embodiments of the present disclosure;

FIGS. 4A-4C are perspective views of the therapeutic device of FIG. 2 with a second tensioning system according to embodiments of the present disclosure; and

FIG. 5 is a flowchart illustrating an example simplified procedure for treating carpal tunnel syndrome using the therapeutic device of FIG. 2.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

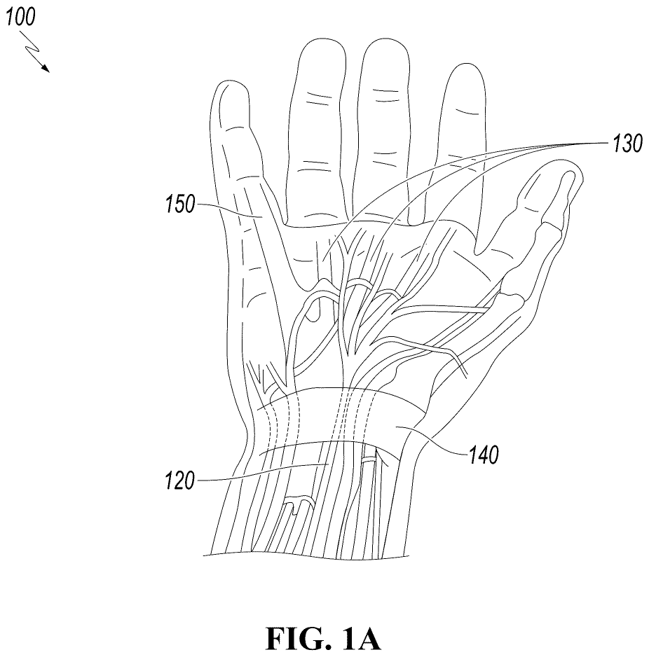

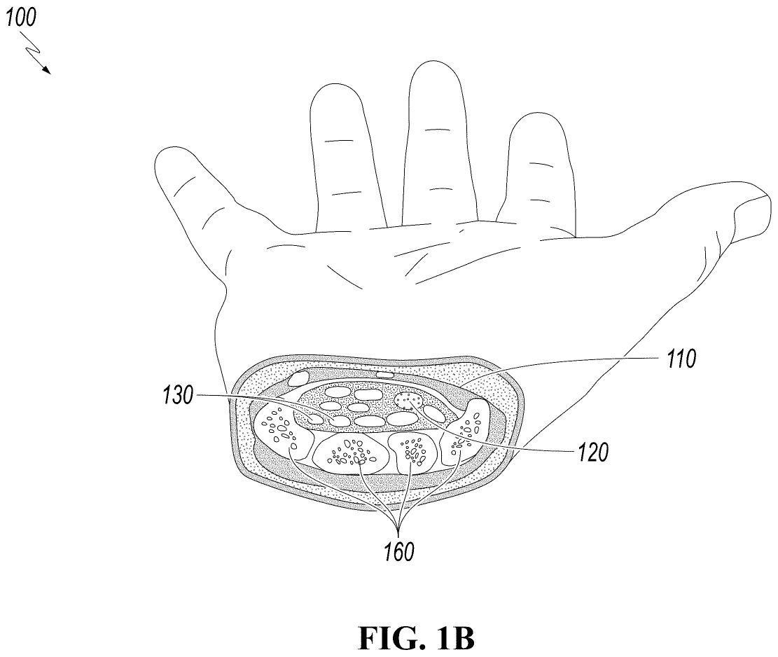

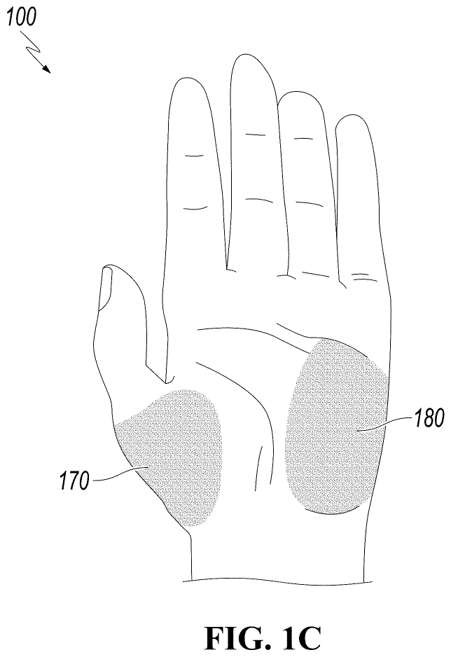

At the outset, FIGS. 1A-1C are anatomical diagrams of the wrist and hand 100 showing structures pertinent to carpal tunnel syndrome, which is caused by pressure on the median nerve 120 as it travels through the carpal tunnel 110. As illustrated in FIGS. 1A and 1B, the carpal tunnel 110 is a narrow passageway in the wrist roughly defined by carpal bones 160 along the floor and sides of the tunnel and the transverse carpal ligament 140 along the roof of the tunnel. The median nerve 120, one of the main nerves in the hand 100, travels down the upper arm, into the forearm, and then passes through the carpal tunnel 110 at the wrist on its way to the hand and fingers. The median nerve 120 separates into smaller nerves once it reaches the palm, allowing for feeling in the fingers and thumb, and also controls muscles of the fingers and thumb in conjunction with the flexor tendons 130. The flexor tendons 130, which function to flex the fingers and thumb, travel through the carpal tunnel 110 alongside the median nerve 120. When the tissue (i.e., synovium 150) surrounding the flexor tendons 130 swells, putting pressure on the median nerve 120 and reducing its blood supply, carpal tunnel syndrome can occur as the carpal tunnel 110 itself has little capacity to stretch or increase in size. The phenomenon often results in numbness, tingling, pain, and weakness in the hand.

The hand 100 includes two muscle groups often targeted by physical therapists in treating carpal tunnel syndrome: thenar muscles 170 and hypothenar muscles 180, as shown in FIG. 1C (also referred to as the thenar eminence and hypothenar eminence). Located at the base of the thumb, the thenar muscles 170 control movement of the thumb, while the hypothenar muscles 180 are located at the base of the pinky and control movement of the pinky. Both muscle groups originate in the carpal bones 160 and are innervated by the median nerve 120. The thenar and hypothenar muscles 170, 180 are thus affected by carpal tunnel syndrome, leading to symptoms such as thumb pain, difficulty with hand movements, and even muscle atrophy.

Accordingly, and as described below, the presently disclosed therapeutic device seeks to treat carpal tunnel syndrome by providing a wearable glove-like device configured to apply torque to the thenar and hypothenar muscles 170, 180, in turn stretching the transverse carpal ligament 140 and thereby relieving pressure on the median nerve 120. When used over time, the disclosed device can relieve common symptoms of carpal tunnel syndrome and chronic wrist pain, avoiding invasive forms of intervention such as surgery.

In further detail, the disclosed therapeutic device can be worn as a glove and create torque, either manually or by other mechanical means such as a motor, to the flexor surface of the wrist. In some embodiments, the torque can be applied by the device according to a predefined algorithm which defines a torque application schedule to simulate a stretching routine a trained physical therapist might perform on the user. Application of the torque can be implemented by a tensioning system coupled to the glove. The tensioning system can include both a tensioning wire and a tension controlling element that adjustably controls the tension of the wire. In operation, the device can move the hand into dorsiflexion while releasably stretching the thenar and hypothenar muscles 170, 180, thereby stretching out the carpal tunnel 110 and in effect relieving pressure on the median nerve 120.

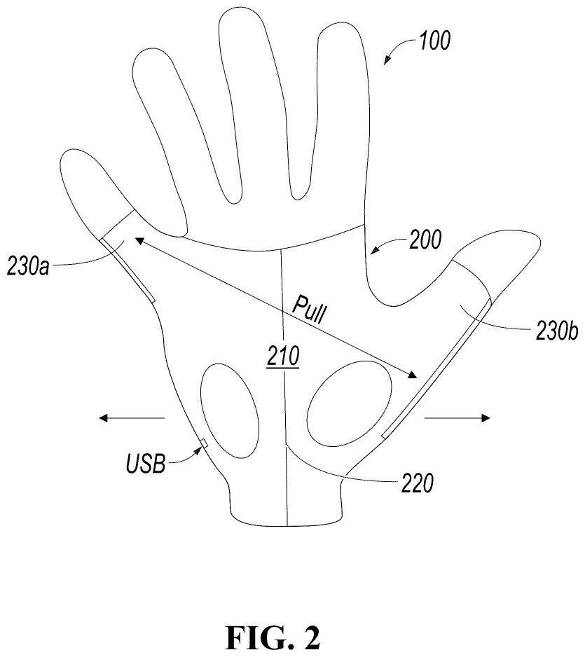

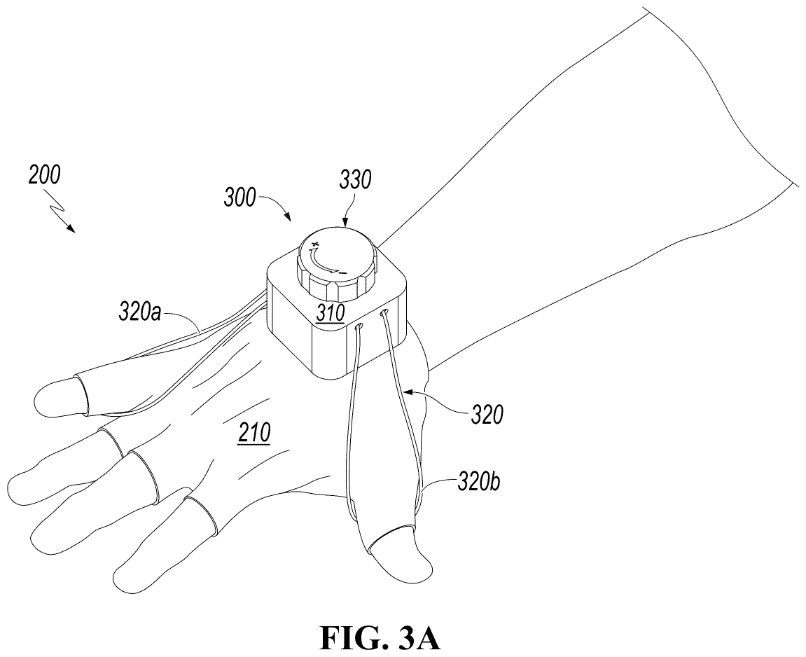

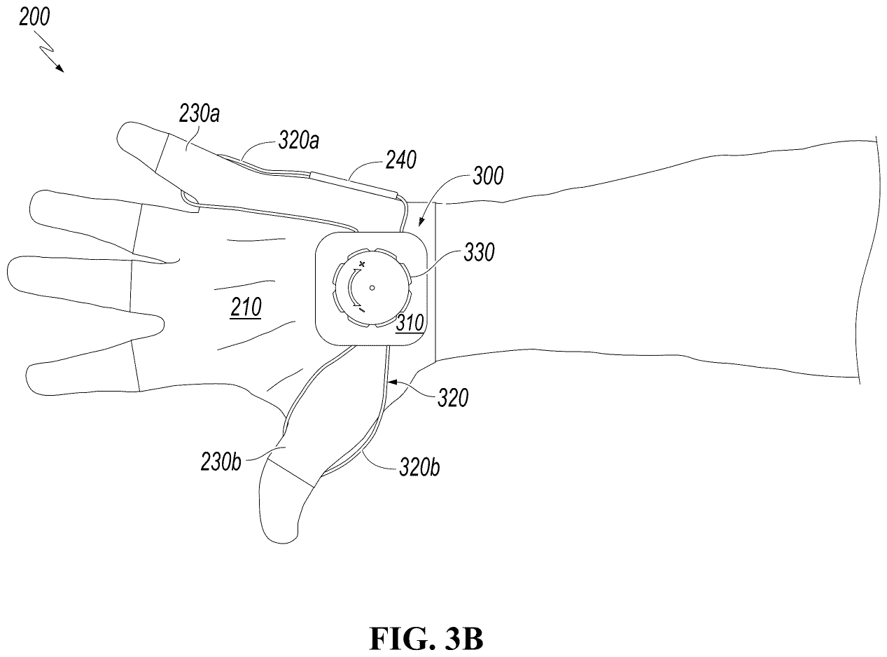

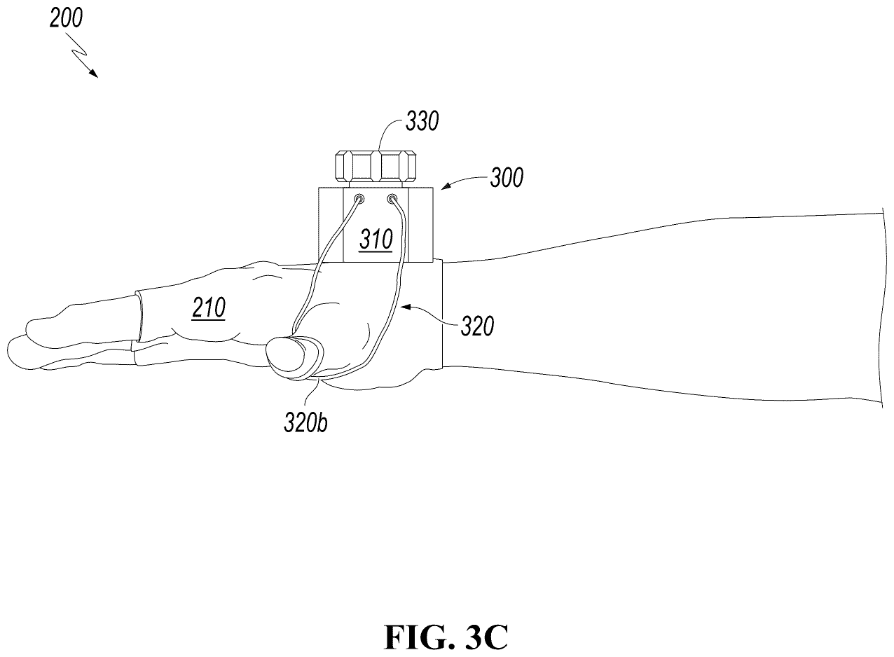

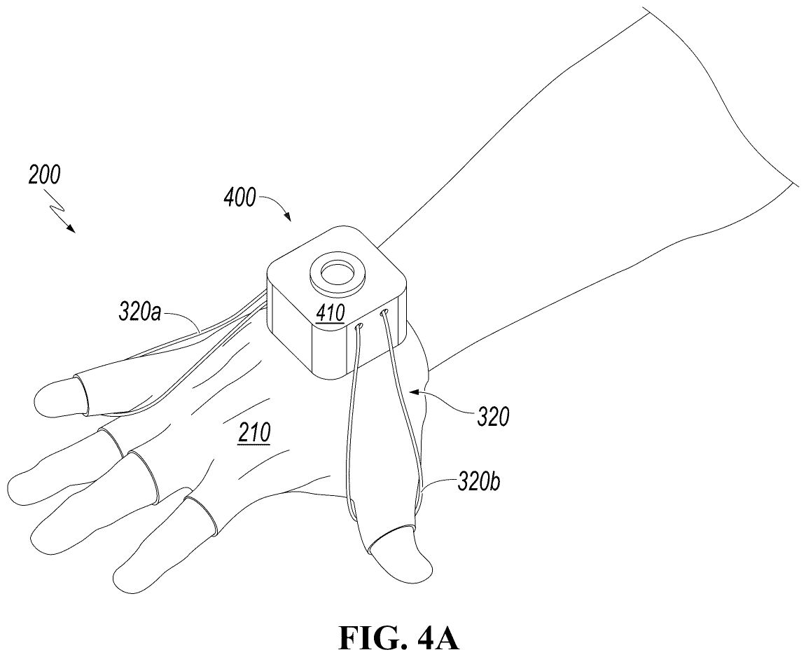

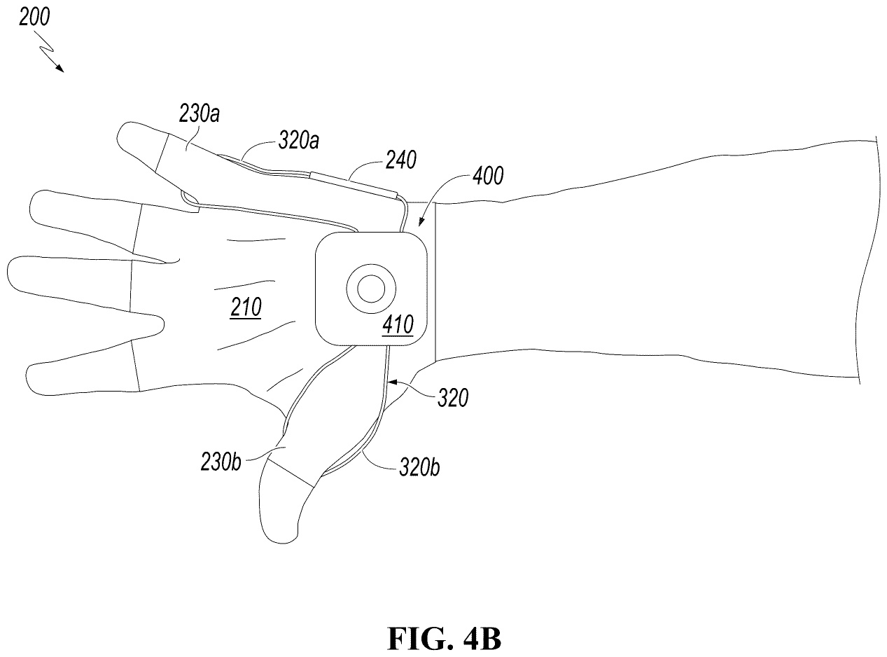

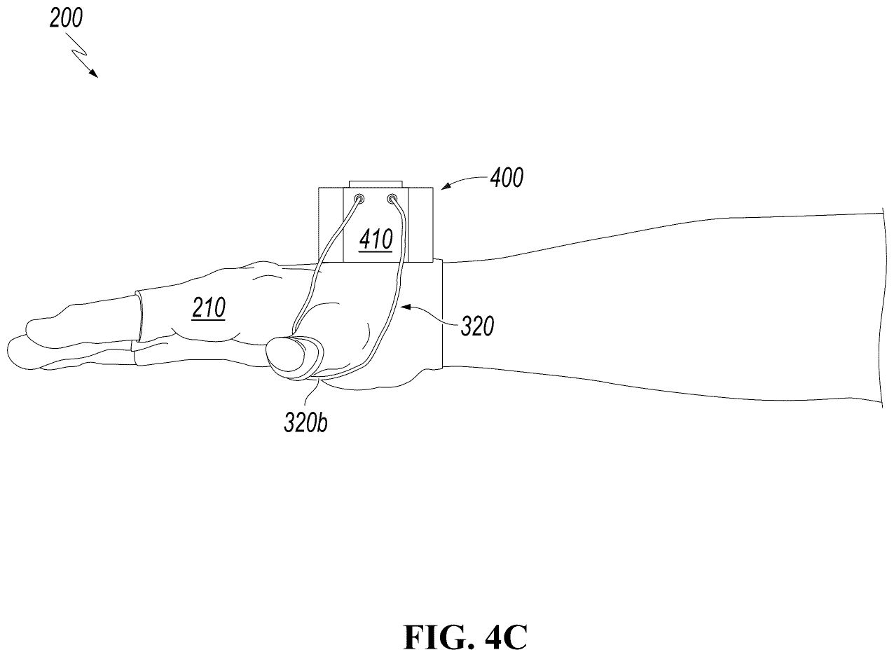

FIG. 2 is a simplified sketch of a therapeutic device 200 for treating carpal tunnel syndrome according to embodiments of the present disclosure. As shown, the therapeutic device 200 can include a glove 210 configured to be worn on a hand 100 of a user. The body of the glove 210 can be constructed using any suitable material or combination of materials including, but not limited to, leather, vinyl, rubber, polyurethane, neoprene, latex, cotton, and so on. The glove 210 can include a palm section 220 accommodating a palm of the hand 100. The palm section 220 can partially or fully surround the user's palm in a similar fashion to a conventional glove. The palm section 220 can be coupled to an adjustment means (not shown), such as a buckle, a strap, a zipper, a button, or the like, allowing a user to adjust the size and fit of the glove 210 to the user's hand 100 to secure the glove 210 in place. The glove 210 can further include a plurality of finger sections 230 each of which accommodating a finger of the hand 110. In one embodiment, shown in FIG. 2, the glove 210 can include two finger sections: a first finger section 230a accommodating the user's pinky and a second finger section 230b. In another embodiment, shown in FIGS. 3A-4C, the glove 210 can include additional finger sections 230 accommodating each of the user's intermediate fingers. The embodiments of the present disclosure are not limited thereto, however, as the glove 210 can include any number and arrangement of finger sections 230.

To achieve the desired stretching of the carpal tunnel 110 as described below, it is beneficial for the finger sections 230 to include at least the first finger section 230a accommodating the user's pinky and the second finger section 230b accommodating the user's thumb, consistent with the present figures. As torque is applied to the hand 100 by the tensioning system described below via the glove 210, the first finger section 230a and the second finger section 230b can pull the pinky and thumb, respectively, toward a posterior side of the hand 100, as demonstrated in FIG. 2. This stretching movement, in conjunction with dorsiflexion of the hand 100, can implement a stretch of the carpal tunnel 110 which relieves pressure on the median nerve 120.

FIGS. 3A-4C are perspective views of the therapeutic device 200 with a tensioning system according to embodiments of the present disclosure. Fundamentally, the tensioning system can include two primary components: a tension controlling element (e.g., tension controlling elements 310, 410) and a tensioning wire 320. The tension controlling element can be affixed, either removably or permanently, to the glove 210 and located at a posterior side of the hand 110 or wrist of the user, as shown, allowing for a user to easily manipulate the tension controlling element while wearing the glove 210. The tension controlling element can include a housing encompassing various componentry that is configured to adjustably control a tension of the tensioning wire 320, as described below.

The tensioning wire 320 can be constructed using any suitable material or combination of materials including, but not limited to, stainless steel, Kevlar, nylon, rubber, polyethylene, and so on. As shown in FIGS. 3A-4C, the tensioning wire 320 can include multiple sections, such as a first section 320a and a second section 320b. These sections can be coupled to specific finger sections 230 of the glove 210. For example, the first section 320a can be coupled to the first finger section 230a, and the second section 320b can be coupled to the second finger section 230b, as shown, such that the first section 320a of the tensioning wire 320 applies torque to the user's pinky, while the second section 320b of the tensioning wire 320 applies torque to the user's thumb.

The manner by which the tensioning wire 320 can be coupled to the finger sections 230 of the glove 210 can vary. In one embodiment, as illustrated in FIGS. 3A-4C, the tensioning wire 320 can wrap around the finger sections 230. For instance, the first section 320a of the tensioning wire 320 can wrap around the first finger section 230a, and the second section 320b of the tensioning wire 320 can wrap around the second finger section 320b. In another embodiment, the tensioning wire 320 can attach to the finger sections 230. For instance, the first section 320a of the tensioning wire 320 can be attached to the first finger section 230a, and the second section 320b of the tensioning wire 320b can be attached to the second finger section 230b. In yet another embodiment, the glove 210 can include a lumen (not shown) through which the tensioning wire 320 can pass, thereby enclosing a portion of the tensioning wire 320 within the glove 210. For instance, the first finger section 230a can include a first lumen within which a portion of the first section 320a of the tensioning wire 320 is located, and the second finger section 230b can include a second lumen within which a portion of the second section 320b of the tensioning wire 320 is located. It is to be understood that these embodiments are non-limiting, and any other technique suitable for coupling the tensioning wire 320 to the finger sections 230 of the glove 210 are envisioned.

As the tension controlling element (e.g., tension controlling element 310, 410) adjusts the tension of the tensioning wire 320, torque is applied by the tensioning wire 320 onto the user's hand causing a stretch of the carpal tunnel 110. In particular, the thenar and hypothenar muscles 170, 180 of the hand 100 can be stretched in response to the tension controlling element increasing the tension of the tensioning wire 320. The increase in tension of the tensioning wire 320 can impart torque onto the user's hand, thus effecting movement of the fingers and thumb. Specifically, the tensioning wire 320 can apply torque laterally at the thenar muscles 170 and medially at the hypothenar muscles 180, causing the thumb and the pinky to be pulled toward a posterior side of the hand 100. Furthermore, as the tension controlling element increases the tension of the tensioning wire 320, the applied torque can bend the hand 100 into dorsiflexion (bending the hand upward), simultaneous with the stretch of the thenar and hypothenar muscles 170, 180, thereby stretching the transverse carpal ligament 140. The combined torque can stretch the carpal tunnel 110 and in turn relieve pressure on the median nerve 120. Conversely, the stretch of the thenar and hypothenar muscles 170, 180 can be released in response to the tension controlling element decreasing the tension of the tensioning wire 320.

In some embodiments, the glove 210 can include one or more routing elements coupled to the tensioning wire 320 and configured to route the tensioning wire 320 along particular regions of the hand to ensure the torque applied by the tensioning wire 320 onto the user's hand stretches the carpal tunnel 110 effectively. For example, the glove 210 can include a routing element 240 adjacent to the hypothenar muscles 180, as shown in FIGS. 3B and 4B. The routing element 240 can be coupled to the tensioning wire 320 in a manner such that the first section 320a of the tensioning wire 320 is routed along the length of the hypothenar muscles 180 (e.g., from the pinky toward the base of the palm) prior to reaching the tension controlling element 310, 410. In doing so, the routing element 240 ensures the torque applied to the user's hand effectively stretches the entirety of the hypothenar portion. Though not shown in the figures, additional routing elements can be implemented to similarly route the second section 320b of the tensioning wire 320 and enhance the stretch of the carpal tunnel 110.

Structurally, the routing element 240 can adopt various forms suitable for routing the tensioning wire 320 along a particular region of the hand. For example, the routing element 240 can include a sleeve or other lumen with an interior passageway through which a portion of the tensioning wire 320 passes. The routing element 240 could alternatively include a block, a wheel, a hook, or any other object protruding from an exterior of the glove 210, whereby a portion of the tensioning wire 320 wraps around the routing element (rather than passing through an interior passageway).

Utilizing the tension controlling element to adjustably control the tension of the tensioning wire 320 over specific periods of time can implement a stretching protocol, as prescribed by a physical therapist, for example, that ultimately relieves symptoms of carpal tunnel syndrome. In one embodiment, a prescribed stretching protocol may include a sequence of steps in which the tension of the tensioning wire 320 is increased or decreased via the tension controlling element by specific amounts for specific periods of time. One such sequence may include the following steps:
1) Apply torque to the thenar and hypothenar muscles 170, 180 by increasing the tension of the tensioning wire 320 via the tension controlling element to a torque amount of 10 inch-pounds (In·Lb) for a time period of 30 seconds.
2) Deflate the torque applied to the thenar and hypothenar muscles 170, 180 by decreasing the tension of the tensioning wire 320 via the tension controlling element to a torque amount of 2 In·Lb for a time period of 10 seconds.
3) Apply torque to the thenar and hypothenar muscles 170, 180 by increasing the tension of the tensioning wire 320 via the tension controlling element to a torque amount of 15 In·Lb for a time period of 30 seconds (the torque applied to the hand is greater than the torque initially applied in step 1).
4) Release the stretch by fully decreasing the tension of the tensioning wire 320 via the tension controlling element such that torque is no longer applied to the hand.

The stretching protocol can be repeated any number of times until treatment is complete. It should be appreciated that the above stretching protocol does not limit the scope of the present disclosure in any way and is provided merely for illustration purposes.

Various exemplary configurations of the tension controlling element will now be described. Referring first to FIGS. 3A-3C, the therapeutic device 200 can include a first tensioning system 300 with a tension controlling element 310. In general, the tension controlling element can employ a variety of mechanisms to either increase or decrease the tension of the tensioning wire 320 in response to user manipulation of the tension controlling element. In one embodiment, as shown, the tension controlling element 310 can include a rotary knob 330 configured to increase or decrease the tension of the tensioning wire 320 via manual rotation of the knob. The rotary knob 330, for example, can be coupled to a ratcheting mechanism, a gear assembly, a string gauge, or the like (not shown) at least partially located within the housing of the tension controlling element 310 that reversibly tightens the tensioning wire 320. Rotation of the rotary knob 330 can actuate the ratcheting mechanism to cause tightening or untightening (i.e., release) of the tensioning wire 320, thereby increasing or decreasing the tension caused by the tensioning wire 320 imparted onto the finger sections 230 of the glove. In some embodiments, the glove 210 can include padding in various areas, such as underneath the rotary knob 330, to prevent potential discomfort as greater degrees of torque are applied by the tensioning system 300.

The rotary knob 330 can be manually controlled by the user in various ways. For example, the rotary knob 330 can be configured such that rotation of the rotary knob 330 in a first direction (e.g., clockwise) causes the tension of the tensioning wire 320 to increase, while rotation of the rotary knob 330 in a second direction (e.g., counter-clockwise) causes the tension of the tensioning wire 320 to decrease. In another example, the rotary knob 330 can be configured such that the tension of the tensioning wire 320 decreases in response to an upward pull exerted on the rotary knob 330 which temporarily disengages the rotary knob 330 from the ratcheting mechanism within the tension controlling element 310. In such case, the rotary knob 330 can be pushed downwardly back into its original position to reengage with the ratcheting mechanism, upon which rotation of the rotary knob 330 in the first direction can cause the tension of the tensioning wire 320 to increase.

Additionally, in some embodiments, the glove 210 can provide a visual indicator (not shown) that shows the current level of torque being applied by the tensioning system 300. For example, the visual indicator can be operatively coupled to the tension controlling element 310 such that adjustment of the tension controlling element 310 effects a corresponding change in the visual indicator, offering the user a way of simply and accurately measuring the degree of torque being applied. Such visual indicator can also aid the user when following a prescribed exercise in which the user must manipulate the tensioning system 300 to apply precise amounts of torque over time.

Referring next to FIGS. 4A-4C, the therapeutic device 200 can include a second tensioning system 400 with a tension controlling element 410. Unlike the tension controlling element 310 which requires the user to manually rotate the rotary knob 330 to control the tension of the tensioning wire 320, the tension controlling element 410 can include a motorized gear assembly (not shown) within the housing of the tension controlling element 410. The motorized gear assembly can include, for example, a motor (e.g., DC motor, brush motor, etc.) operatively coupled to a ratcheting mechanism, a gear assembly, or the like that reversibly tightens the tensioning wire 320. In such case, the tension controlling element 410 can receive electrical power via a battery supply, a power cable (e.g., USB), or any other suitable means.

As would be appreciated, the motor can automate the tension adjustment of the tensioning wire 320. The tension controlling element 410 can also include one or more input elements (not shown) configured to control operation of the motorized gear assembly. The input elements could include, for instance, a button, a switch, a lever, a touchscreen, a tap sensor, and so on. Activation of the tension controlling element 410 via the one or more input elements can cause the motorized gear assembly to either increase or decrease the tension of the tensioning wire 320. In some embodiments, the input elements can enable a user to precisely control the amount of torque generated the tensioning wire 320.

In other embodiments, the motorized gear assembly can be configured to operate according to a predefined execution algorithm. For example, the user can activate a predefined execution algorithm, causing the tension controlling element 410 to control the amount of tension of the tensioning wire 320 by predefined amounts and according to predefined time intervals. The tension controlling element 410 can include the circuitry, memory, and processing elements necessary to store and execute the algorithm. Such circuitry, memory, and processing elements are well-known in the art and will not be described herein. The execution algorithm can cause the motorized gear assembly of the tension controlling element 410 to automatically increase and decrease the tension of the tensioning wire according to a predefined schedule and by predefined amounts of torque. Such algorithm can simulate a stretching protocol prescribed by a physical therapist, for example, although it should be appreciated by a person of ordinary skill in the art that any number of execution algorithms may be carried out by the tension controlling element 410.

Furthermore, the device 200 can integrate other elements for delivering various additional therapeutic techniques that supplement the tensioning system described above in treating carpal tunnel syndrome and wrist pain generally. For example, in some embodiments, the device 200 can be equipped with a device for providing electrical muscle stimulation (EMS), such as an EMS pad, built in or otherwise integrated into the glove 210, to relieve gait pain and to help strengthen and retrain muscles in the user's wrist or hand. In further embodiments, the device 200 can be configured to provide massage and myofascial release by performing the Graston technique or other similar techniques, using a built-in tool configured to apply pressure across the soft tissue. Similarly, the device 200 can be designed to supply varying degrees of pressure to the soft tissue, space occupying lesion, and ulnar nerve in the user's wrist as another means for relieving wrist pain (e.g., ulnar tunnel syndrome). The device 200 can be configured to deliver other types of stimuli to the carpal tunnel ligament and surrounding areas as well, such as acupuncture, massage, temperature (e.g., heating or cooling), vibration, ultrasound, and so forth, with the intention of offering the user a variety of options for treating carpal tunnel syndrome and other forms of wrist pain.

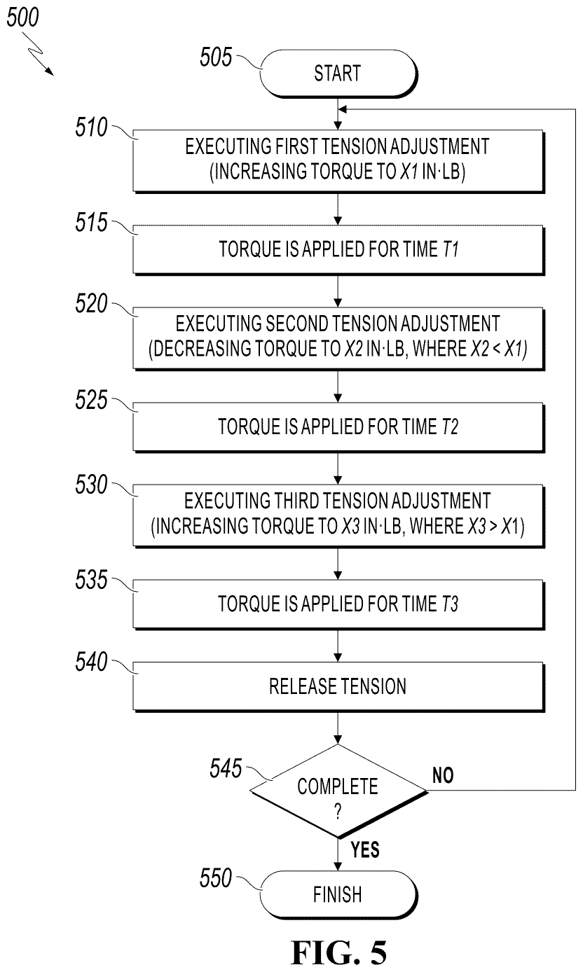

For illustration purposes, FIG. 5 is a flowchart illustrating an example simplified procedure for treating carpal tunnel syndrome using the therapeutic device 200, as implemented via the tension controlling element 410. The procedure 500 can start at step 505 and proceed to step 510 where a first tension adjustment can be executed by the tension controlling element 410 in which the motorized gear assembly increaseS the tension of the tensioning wire 320 to a first amount of torque X1 In·Lb. This tension can be applied and maintained for a first period of time T1 (step 515).

At step 520, a second tension adjustment can be executed by the tension controlling element 410 to temporarily release, either partially or fully, the stretch of the carpal tunnel 110. The motorized gear assembly can decrease the tension of the tensioning wire 320 to a second amount of torque X2 In·Lb which is less than the first amount of torque X1. This tension can be applied and maintained for a second period of time T2 (step 525), which may be equal to or different than the first period of time T1. Alternatively, the tension of the tensioning wire 320 can be fully released so that no torque is applied.

At step 530, a third tension adjustment can be executed by the tension controlling element 410 in which the motorized gear assembly can increase the tension of the tensioning wire 320 once again, this time to a third amount of torque X3 In·Lb which is greater than the first amount of torque X1. This tension can be applied and maintained for a third period of time T3 (step 535), which may be equal to or different than the first and second periods of time T1, T2.

At step 540, the tension of the tensioning wire 320 can be fully released such that no torque is imparted onto the hand 100. This sequence may be repeated any number of times until the treatment is complete. If the stretching sequence (i.e., steps 510-540) has been completed the prescribed number of times, the process 500 may finish at step 550. Alternatively, the entire stretching sequence can be repeated starting with step 510 until the sequence is complete.

Accordingly, the therapeutic device disclosed herein has been designed to treat carpal tunnel syndrome and related forms of wrist pain by reducing or relieving symptoms and avoiding surgical intervention. The therapeutic device includes an adjustable glove coupled to a tensioning system configured to create torque over time to the flexor surface of the wrist, thereby stretching the carpal tunnel. Unlike conventional solutions, such as splints, that merely keep the wrist locked in a single position, the presently disclosed therapeutic device generates measured amounts of pressure based upon degrees of torque that are implemented over time. Moreover, the therapeutic device is user-friendly, as it is easy to operate, readily accessible, and able for use at home, at work, or during travel, with continued treatment as needed.

The foregoing description has been directed to embodiments of the present disclosure. It will be apparent, however, that other variations and modifications may be made to the described embodiments, with the attainment of some or all of their advantages. For example, embodiments are envisioned in which, in addition to the above, the presently disclosed therapeutic device provides electrical muscle stimulation and/or myofascial release or massage throughout the treatment cycle.

Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. An apparatus for treating carpal tunnel syndrome, the apparatus comprising:
a glove configured to be worn on a hand of a user, the glove comprising a palm section accommodating a palm of the hand and a plurality of finger sections each of which accommodating a finger of the hand when in use; and
a tensioning system comprising:
a tensioning wire including a first section coupled to a first finger section of the plurality of finger sections and a second section coupled to a second finger section of the plurality of finger sections, and
a tension controlling element for adjustably controlling a tension of the tensioning wire,
wherein the tension controlling element is configured to increase the tension of the tensioning wire, causing a stretch of thenar muscles and hypothenar muscles of the hand when in use, and configured to decrease the tension of the tensioning wire, causing a release of the stretch of the thenar and hypothenar muscles when in use.

2. The apparatus of claim 1, wherein, when the tension controlling element increases the tension of the tensioning wire, the tensioning wire is configured to apply torque to the thenar and hypothenar muscles, causing the stretch.

3. The apparatus of claim 2, wherein the torque is applied laterally at the thenar muscles and medially at the hypothenar muscles.

4. The apparatus of claim 2, wherein, when the tension controlling element decreases the tension of the tensioning wire, the tensioning wire is configured to reduce the torque applied to the thenar and hypothenar muscles, causing the release of the stretch.

5. The apparatus of claim 1, wherein, when the tension controlling element increases the tension of the tensioning wire, the hand is caused to bend into dorsiflexion while the thenar and hypothenar muscles are stretched.

6. The apparatus of claim 1, wherein the tensioning wire is at least partially located within of a lumen of the glove.

7. The apparatus of claim 6, wherein the first finger section includes a first lumen within which the first section of the tensioning wire is located, and the second finger section includes a second lumen within which the second section of the tensioning wire is located.

8. The apparatus of claim 1, wherein the first section of the tensioning wire is attached to the first finger section, and the second section of the tensioning wire is attached to the second finger section.

9. The apparatus of claim 1, wherein the first section of the tensioning wire wraps around the first finger section, and the second section of the tensioning wire wraps around the second finger section.

10. The apparatus of claim 1, wherein the first finger section is configured to accommodate a pinky of the hand, and the second finger section is configured to accommodate a thumb of the hand.

11. The apparatus of claim 6, wherein, when the tension controlling element increases the tension of the tensioning wire, the thumb and the pinky are pulled toward a posterior side of the hand when in use.

12. The apparatus of claim 1, wherein the tension controlling element comprises a rotary knob configured to increase or decrease the tension of the tensioning wire.

13. The apparatus of claim 12, wherein the rotary knob is configured such that rotation of the rotary knob in a first direction causes the tension of the tensioning wire to increase, and wherein the rotary knob is further configured such that an upward pull exerted on the rotary knob or rotation of the rotary knob in a second direction causes the tension of the tensioning wire to decrease.

14. The apparatus of claim 1, wherein the tension controlling element comprises a motorized gear assembly configured to increase or decrease the tension of the tensioning wire.

15. The apparatus of claim 14, wherein the tension controlling element further comprises one or more input elements configured to control operation of the motorized gear assembly.

16. The apparatus of claim 14, wherein the motorized gear assembly is configured to operate according to a predefined algorithm, causing the motorized gear assembly to increase and decrease the tension of the tensioning wire according to a predefined schedule and by predefined amounts of torque.

17. The apparatus of claim 16, wherein execution of the predefined algorithm causes the motorized gear assembly to, in order: 1) increase the tension of the tensioning wire to a first amount of torque for a first period of time, 2) decrease the tension of the tensioning wire to a second amount of torque less than the first amount of torque for a second amount of time, and 3) increase the tension of the tensioning wire to a third amount of torque greater than the first amount of torque for a third period of time.

18. The apparatus of claim 1, wherein the tension controlling element is located at a posterior side of the hand or a wrist of the user when in use.

19. The apparatus of claim 1, wherein the glove further comprises a routing element adjacent to the hypothenar muscles, the routing element being coupled to the tensioning wire and configured to route a portion of tensioning wire along a length of the hypothenar muscles.

20. A method for treating carpal tunnel syndrome using a glove configured to be worn on a hand of a user, the glove comprising a palm section accommodating a palm of the hand and a plurality of finger sections each of which accommodating a finger of the hand when in use, the method comprising:
executing, via a tension controlling element, a first adjustment of tension of a tensioning wire in which the tension of the tensioning wire is increased to a first amount of torque for a first period of time, causing a stretch of thenar muscles and hypothenar muscles of the hand;
executing, via the tension controlling element, a second adjustment of tension of the tensioning wire in which the tension of the tensioning wire is decreased to a second amount of torque less than the first amount of torque for a second period of time, causing a release of the stretch of the thenar and hypothenar muscles; and
executing, via the tension controlling element, a third adjustment of tension of the tensioning wire in which the tension of the tensioning wire is increased to a third amount of torque greater than the first amount of torque for a third period of time, causing an additional stretch of the stretch of the thenar and hypothenar muscles,
wherein the tensioning wire includes a first section coupled to a first finger section of the plurality of finger sections and a second section coupled to a second finger section of the plurality of finger sections.
